(19) United States
(12) Patent Application Publication
(10) Pub. No.: US 2026/0228185 A1
(43) Pub. Date: Aug. 6, 2026

(54) STORAGE SYSTEM MANAGEMENT METHOD AND SYSTEM

(71) Applicant: Hitachi Vantara, Ltd., Yokohama-shi (JP)

(72) Inventors: Jumpei OKOSHI, San Jose, CA (US); Hiroyuki OSAKI, Los Gatos, CA (US)

(21) Appl. No.: 19/041,994

(22) Filed: Jan. 31, 2025

(51) Int. Cl. G06F 16/21

(52) U.S. Cl. CPC G06F 16/21

(57) ABSTRACT

Example implementations described herein can involve a system for integrated management of a database system and a storage system, wherein the system is configured to receive a configuration request for deployment of a database comprising system requirements for the database; obtain storage configuration information of a storage system to which the database is to be deployed; and generate a database configuration for the database based on the system requirements and the storage configuration information, the database configuration generated to fulfill the system requirements based on available functionality specified in the storage configuration information.

### BACKGROUND

### Field

The present disclosure is generally related to storage systems, and more specifically to configuration management of databases for storage systems.

### Related Art

In the related art, there are industries that manage both database (DB) and storage with concerns about the cost of the operation and resource utilization. Such industries can utilize cloud storage solutions including hybrid cloud environments, databases, and storage systems, as well as the storage management plug-in for middleware.

In the related art, there are implementations that allow for the provisioning of databases that take into account resource allocation, but do not consider the duplication of functionality with storage. There are further implementations that allow for the configuration of disaster recovery (DR) that takes storage into account, but does not consider the functionality of the database built on the storage.

Existing technologies support the provisioning of databases and storage systems independently, however, the duplication of functionalities between the each layer is not considered. For example, when trying to achieve high availability, duplicated configurations between the database and storage systems may cause operational complexity and resource waste.

In typical DB and storage systems, some functionalities such as availability and scalability are duplicated, causing problems in terms of operational costs and resource utilization. In the related art, the functionalities of DB and storage are managed independently, and the duplication of functionalities is not considered.

### SUMMARY

Example implementations described herein are directed to reducing the operational complexity and resource waste by considering the duplication and trade-offs of functionalities between the database and storage systems.

Example implementations described herein provide a system that integrates the management of database and storage systems, which accepts system requirements and configuration requests, acquires configuration information of the storage system, and outputs the configuration of the database according to the requirements and configuration information.

Example implementations described herein are related to a system that further determines the adequacy of the requirements and proposes the use of some storage functions based on policies.

In example implementations described herein, the Configuration Management System is designed to manage the configuration of the database system and storage system based on the received requirements and storage system information. The Configuration Management System also evaluates the database configuration based on the requirements and storage system capabilities. The Configuration Management System also facilitates enhancements or optimizations based on predefined policies if the requirements are not satisfied.

Example implementations described herein include the above-mentioned system and a method for managing the configuration of the database system and storage system reducing operational complexity and resource waste by considering the duplication and trade-offs of functionalities between the database and storage systems.

Aspects of the present disclosure can involve a system for integrated management of a database system and a storage system, wherein the system is configured to receive a configuration request for deployment of a database comprising system requirements for the database; obtain storage configuration information of a storage system to which the database is to be deployed; and generate a database configuration for the database based on the system requirements and the storage configuration information, the database configuration generated to fulfill the system requirements based on available functionality specified in the storage configuration information.

Aspects of the present disclosure can involve a method for integrated management of a database system and a storage system, which can include receiving a configuration request for deployment of a database comprising system requirements for the database; obtaining storage configuration information of a storage system to which the database is to be deployed; and generating a database configuration for the database based on the system requirements and the storage configuration information, the database configuration generated to fulfill the system requirements based on available functionality specified in the storage configuration information.

Aspects of the present disclosure can involve a computer program for integrated management of a database system and a storage system, which can include instructions for receiving a configuration request for deployment of a database comprising system requirements for the database; obtaining storage configuration information of a storage system to which the database is to be deployed; and generating a database configuration for the database based on the system requirements and the storage configuration information, the database configuration generated to fulfill the system requirements based on available functionality specified in the storage configuration information. The computer program and instructions can be stored on a non-transitory computer readable medium and executed by one or more processors.

Aspects of the present disclosure can involve a system for integrated management of a database system and a storage system, which can include means for receiving a configuration request for deployment of a database comprising system requirements for the database; means for obtaining storage configuration information of a storage system to which the database is to be deployed; and means for generating a database configuration for the database based on the system requirements and the storage configuration information, the database configuration generated to fulfill the system requirements based on available functionality specified in the storage configuration information.

Aspects of the present disclosure can include a configuration management system for integrated management of a database system and a storage system, wherein the system includes a processor, configured to, receive a configuration request for deployment of a database comprising system requirements for the database; obtain storage configuration information of a storage system to which the database is to be deployed; and generate a database configuration for the database based on the system requirements and the storage configuration information, the database configuration generated to fulfill the system requirements based on available functionality specified in the storage configuration information.

### BRIEF DESCRIPTION OF DRAWINGS

FIG. 1 illustrates the software system architecture of the Configuration Management System and other components in accordance with an example implementation.

FIG. 2 illustrates the hardware system architecture of the Configuration Management System, Database System, and Storage System, in accordance with an example implementation.

FIG. 3 illustrates an example flowchart outlining the steps of the Configuration Management System designed to manage database system and storage system based on received requirements and storage system information, in accordance with an example implementation.

FIG. 4 illustrates a table outlining system requirements for the overall performance and reliability to be ensured as configured system, in accordance with an example implementation.

FIG. 5 illustrates a table outlining configurations of the Storage System, in accordance with an example implementation.

FIG. 6 illustrates a table outlining configurations of the Database System, in accordance with an example implementation.

FIG. 7 illustrates an example of configuring the number of replicas in a database system based on availability requirements, in accordance with an example implementation.

FIG. 8 illustrates a policy for replica deduplication based on the presence of RAID 6 configuration and system-level redundancy, in accordance with an example implementation.

FIG. 9 illustrates another example of configuring the number of replicas in a database system based on availability requirements in steps S100-1 to S100-3, in accordance with an example implementation.

FIG. 10 illustrates an example user interface (UI) for configuring a system based on specific requirements and reviewing the corresponding database configuration, in accordance with an example implementation.

FIG. 11 illustrates a user interface (UI) for configuring a policy within a system, in accordance with an example implementation.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means or can be implemented through a desired algorithm. Example implementations as described herein can be utilized either singularly or in combination and the functionality of the example implementations can be implemented through any means according to the desired implementations.

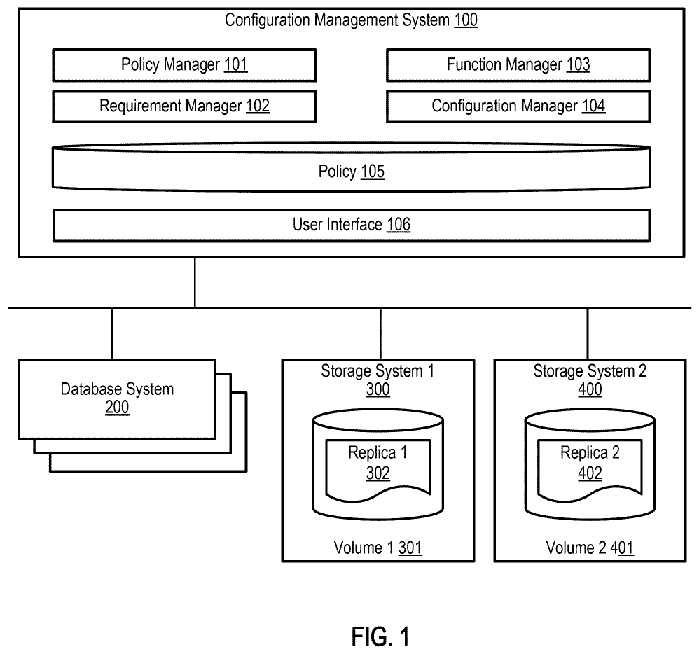

FIG. 1 illustrates the software system architecture of the Configuration Management System (100) and other components in accordance with an example implementation, including the Database System (200), Storage System 1 (300), and Storage System 2 (400).

Configuration Management System (100) can involve various components as follows. Policy Manager (101) manages various policies governing the operation of the database and storage systems. Requirement Manager (102) handles requirements for database and storage systems. Function Manager (103) manages functions of the storage systems, such as performance tuning, scalability features, and functionality enhancements. Configuration Manager (104) manages the configuration of the database and storage systems based on the requirements and policies. Policy (105) stores policies influencing decisions and configurations by the Policy Manager (101). User Interface (106) provides a front-end for system administrators to interact with the Configuration Management System (100), allowing manual inputs and adjustments to system settings.

Database System (200) provides database management functionalities, including data storage, retrieval, and processing.

Storage System 1 (300) and Storage System 2 (400) can involve the following. Volume 1 (301) and Volume 2 (401) represent storage volumes that can be replicated between the two storage systems. Replica 1 (302) and Replica 2 (402) represent replicated data between the storage volumes.

Both storage systems and the database system have replication capabilities. The storage systems can replicate volumes between each other, providing robust data protection and disaster recovery capabilities. The database system, such as modern NewSQL databases, can also configure replicas across attached storage volumes, ensuring high availability and data distribution. The replication capabilities, while used for ensuring data availability, may overlap and lead to unnecessary redundancy. Example implementations described herein aim to optimize the application of these functionalities to avoid excessive redundancy, ensuring that system resources are used efficiently without compromising data protection.

In the following example implementations, the storage system is described in the case of a single storage system. However, as illustrated in FIG. 1, multiple storage systems may be included, or multiple volumes or replicas may be included in a single storage system to facilitate the desired implementation.

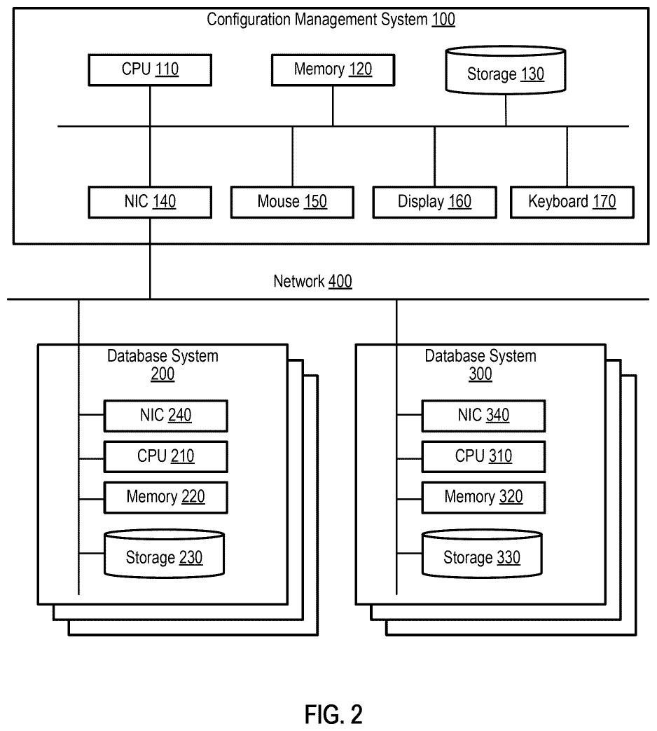

FIG. 2 illustrates he hardware system architecture of the Configuration Management System (100), Database System (200), and Storage System (300), in accordance with an example implementation. The following is a detailed description of the components and their functionalities for each system.

Configuration Management System (100) can involve the following components. Central Processing Unit (CPU) (110) executes instructions and processes for system management and configuration. Memory (120) can include hardware random access memory that stores data temporarily during operation for fast access to active processes. Storage (130) can include physical storage (e.g., hard disk drive, solid-state drive) that stores software, configurations, and system data. Network Interface Card (NIC) (140) facilitates network connectivity for communication with other systems and services. Mouse (150) is a device for point-and-click interface interaction with the system for setup and maintenance. Display (160) is a device for visual output of system status and data, used for monitoring and managing system operations. Keyboard (170) is a device for manual input of commands and configurations into the system.

Database System (200) can include the following components. NIC (240) facilitates network connectivity for communication with other systems and services. CPU (210) processes database queries and transactions efficiently. Memory (220) is hardware that stores data temporarily during operation for fast access to active processes. Storage (230) includes physical storage (e.g., hard disk drive, solid-state drive) that stores software, configurations, and system data.

Storage System (300) can include the following components. NIC (340) facilitates network connectivity for communication with other systems and services. CPU (310) manages storage operations, including data allocation, retrieval, and processing. Memory (320) includes hardware such as random access memory that stores data temporarily during operation for fast access to active processes. Storage (330) can include physical storage (e.g., hard disk drive, solid-state drive) that stores software, configurations, and system data.

Network (400) represents the network infrastructure that connects the Configuration Management System (100), Database System (200), and Storage System (300).

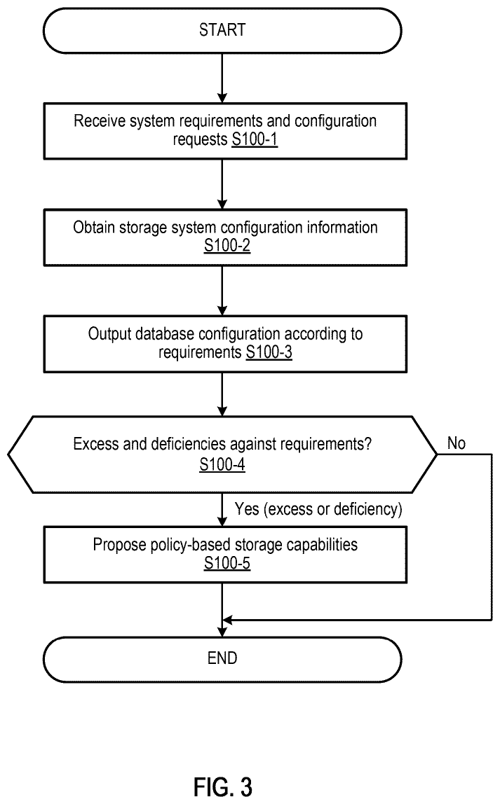

In example implementations described herein, the Configuration Management System (100) is used for integrated management of a Database System (200) and a Storage System (300), wherein the system includes a processor such as CPU (110), configured to execute a method or computer instructions that can include, receive a configuration request for deployment of a database comprising system requirements for the database (S100-1); obtain storage configuration information of a storage system to which the database is to be deployed (S100-2); and generate a database configuration for the database (S100-3) based on the system requirements and the storage configuration information, the database configuration generated to fulfill the system requirements based on available functionality specified in the storage configuration information as described with respect to FIG. 3.

The Configuration Management System (100) can facilitate the method or instructions as described above, wherein the CPU (110) is configured to determine whether the system requirements are fulfilled (S100-4), and enable or disable storage functionalities of the available functionality specified in the storage configuration information based on a predefined policy to adjust the storage configuration information to fulfill the system requirements (S100-5) as described with respect to FIG. 3.

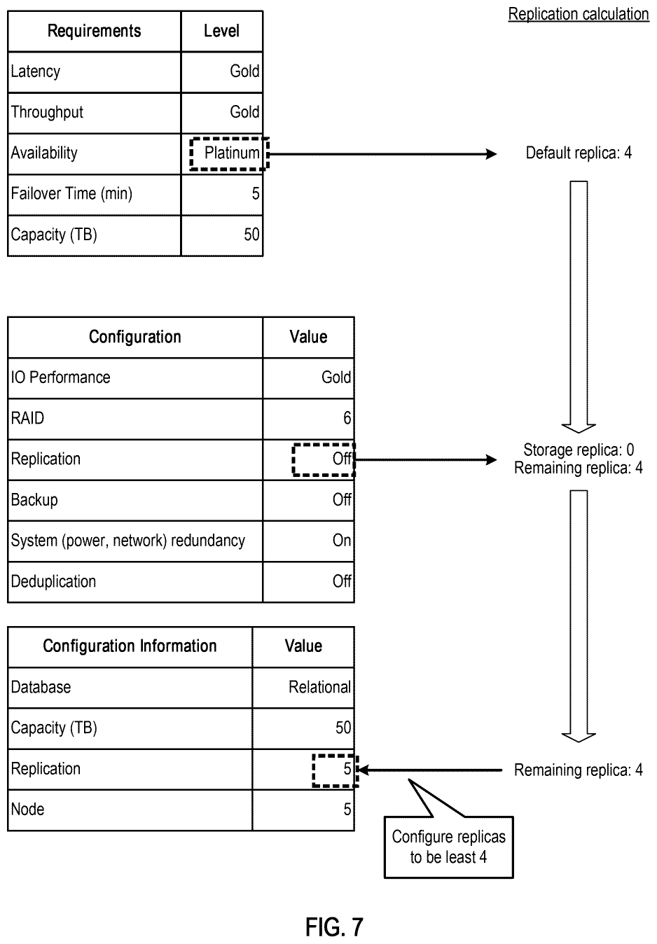

Depending on the desired implementation, when different types of storage functionalities are present in the Storage System (300), the CPU (110) is configured to enable or disable the storage functionalities based on commonality or substitutability of the storage functionalities to optimize available storage resources as described with respect to FIGS. 7-9.

CPU (110) can be configured to execute the method or instructions as described above, and further include instructions or a method to collect performance metrics within the system, generate modifications to the database configuration and the use of the storage functionalities, and dynamically update the database configuration based on the performance metrics as illustrated in FIGS. 3-9. In example implementations, the Configuration Management System (100) can constantly intake desired performance metrics to facilitate dynamic maintenance of efficiency performance. Such metrics can include metrics as defined in the service level agreement. When performance is determined to decrease based on the metrics, then the system can make modifications to the database and storage functionality. Depending on the desired implementation, the performance metrics can include reliability metrics or defined Key Performance Indicators (KPIs) as defined by the software or database engineer.

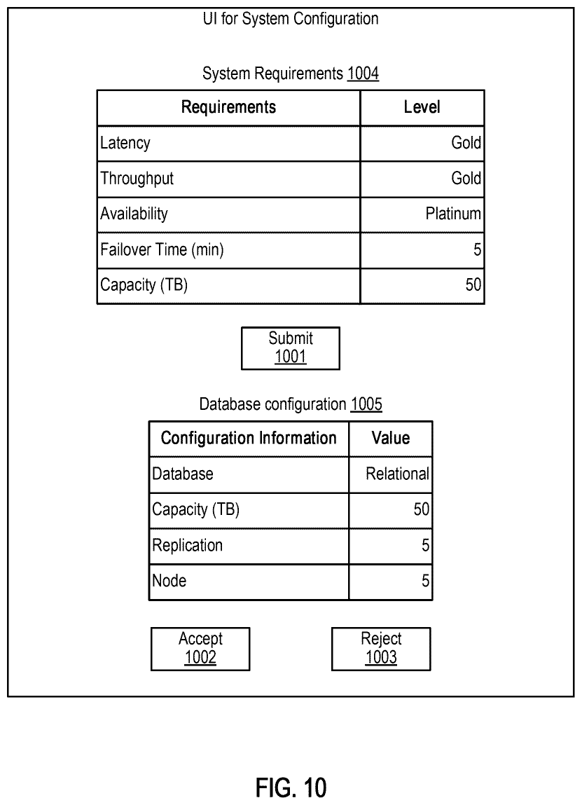

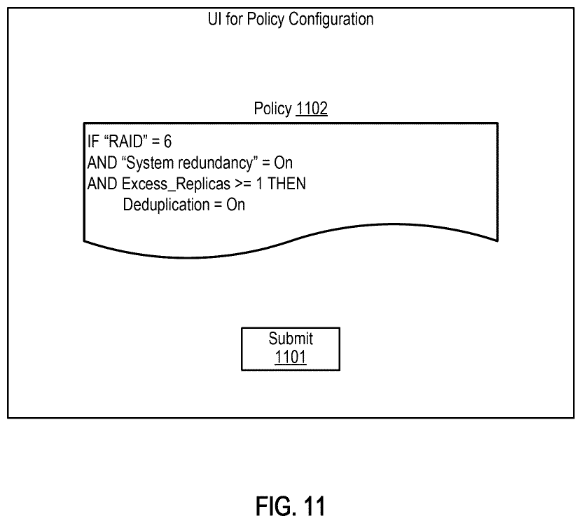

CPU (110) can be configured to execute the method or instructions as described above, and further provide an interface for inputting policies that control the storage functionalities applied when there is an excess or deficiency in meeting the system requirements as illustrated in FIG. 10 and FIG. 11.

FIG. 3 illustrates an example flowchart outlining the steps of the Configuration Management System (100) designed to manage database system and storage system based on received requirements and storage system information, in accordance with an example implementation. The detailed steps are as follows.

Receive system requirements and configuration requests (S100-1): The system receives specific requirements and configuration requests from users or other systems.

Obtain storage system configuration information (S100-2): The system retrieves current configuration information from the storage system to understand the existing resources and capabilities.

Output database configuration according to requirements (S100-3): The system proposes a database configuration based on the input requirements and storage system capabilities.

Determine excesses and deficiencies against requirements (S100-4): The system evaluates whether the proposed system configuration meets the specified requirements. If so (Yes), then an excess or deficiency exists and the flow proceeds to S100-5, otherwise (No) the process ends.

Propose policy-based storage capabilities (S100-5): If the requirements are not satisfied, the system proposes enhancements or optimizations based on predefined policies.

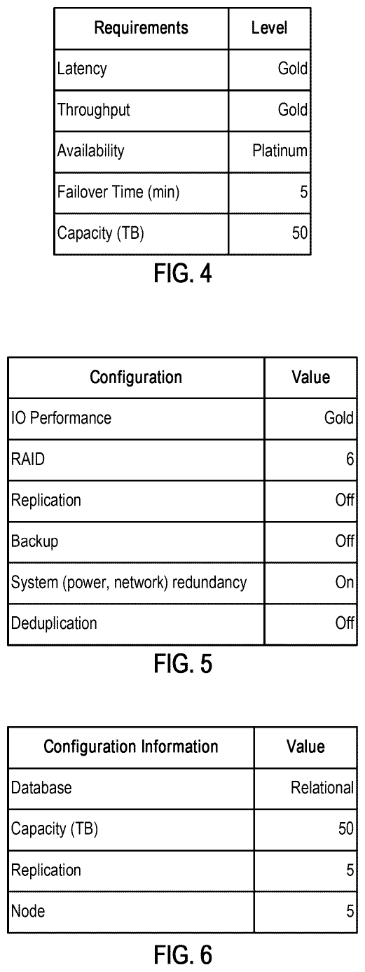

FIG. 4 illustrates a table outlining system requirements for the overall performance and reliability to be ensured as configured system, in accordance with an example implementation. In step S100-1, users or other systems provide system requirements as shown in FIG. 4 through the User Interface (106) using devices such as the mouse (150), keyboard (170), and display (160). The Requirements Manager (102) manage the system requirements.

The system requirements can include the following.
Latency (Gold Level): Minimizing delays for data processing.
Throughput (Gold Level): Sustaining high data transfer rates for processing of data.
Availability (Platinum Level): Ensuring maximum reliability and uptime.
Failover Time (5 Minutes): Quick recovery from failures to maintain service continuity.
Capacity (50 Terabytes): Adequate storage capacity for managing extensive databases and data records.

FIG. 5 illustrates a table outlining configurations of the Storage System, in accordance with an example implementation.

In step S100-2, the Configuration Manager (104) obtains configuration information from the Storage System (300). The Storage Configuration includes the following fields.
IO Performance: Gold
RAID: 6
Replication: Off
Backup: Off
System (power, network) redundancy: On
Deduplication: Off

The above configurations indicates that the storage system is configured for high Input/Output (IO) performance, uses RAID 6 for fault tolerance, has replication and backup features turned off, has system redundancy for power and network enabled, and has deduplication turned off.

FIG. 6 illustrates a table outlining configurations of the Database System (200), in accordance with an example implementation.

In step S100-3, the Configuration Manager (104) outputs a proposed database configuration based on the input requirements and storage system capabilities. The Database Configuration includes the following fields.
Database: Relational
Capacity (TB): 50
Replication: 5
Node: 5

The settings indicates that the database system is based on a relational model, has a storage capacity of 50 terabytes, has a replication factor of 5 for data redundancy, and operates across 5 nodes in a distributed setup.

FIG. 7 illustrates an example of configuring the number of replicas in a database system based on availability requirements in steps S100-1 to S100-3, in accordance with an example implementation.

In this example, the system requirements specify that the availability level is set to “Platinum,” which requires a default number of replicas to be four.

In step S100-2, the Configuration Manager (104) obtains the storage configuration settings and finds that no specific replica configuration is defined at the storage level. In step S100-3, the Configuration Manager (104) proposes to configure the database with 5 replicas instead of the default 4 because the number of replicas should be an odd number due to database specific requirements. In step S100-4, the Configuration Manager (104) judges whether the proposed database configuration meets the specified requirements. In this case, since number of replicas, which is five, exceeds the required number, which is four, the Configuration Manager (104) judges that the proposed database configuration exceeds the specified requirements and moves to the next step S100-5.

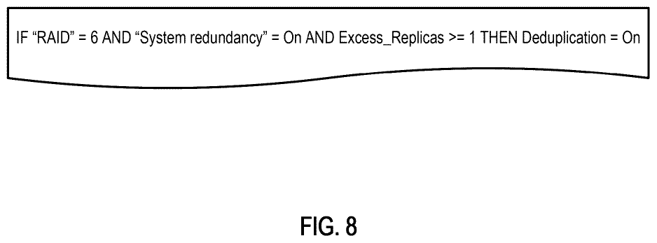

FIG. 8 illustrates a policy for replica deduplication based on the presence of RAID 6 configuration and system-level redundancy, in accordance with an example implementation.

In step S100-5, the Configuration Manager (104) proposes enhancements or optimizations based on predefined policies if the requirements are not satisfied. In this policy, the Configuration Manager (104) proposes to initiate deduplication, which is one of the functions provided by storage system, under the following conditions.

The storage system is configured with RAID 6.

System-level redundancy (e.g., power and network redundancy) is enabled.

There is an excess of replicas beyond the necessary count for maintaining the required redundancy and availability.

By this policy, the Configuration Manager (104) can optimize storage efficiency by removing redundant data while ensuring the system meets its redundancy and availability targets.

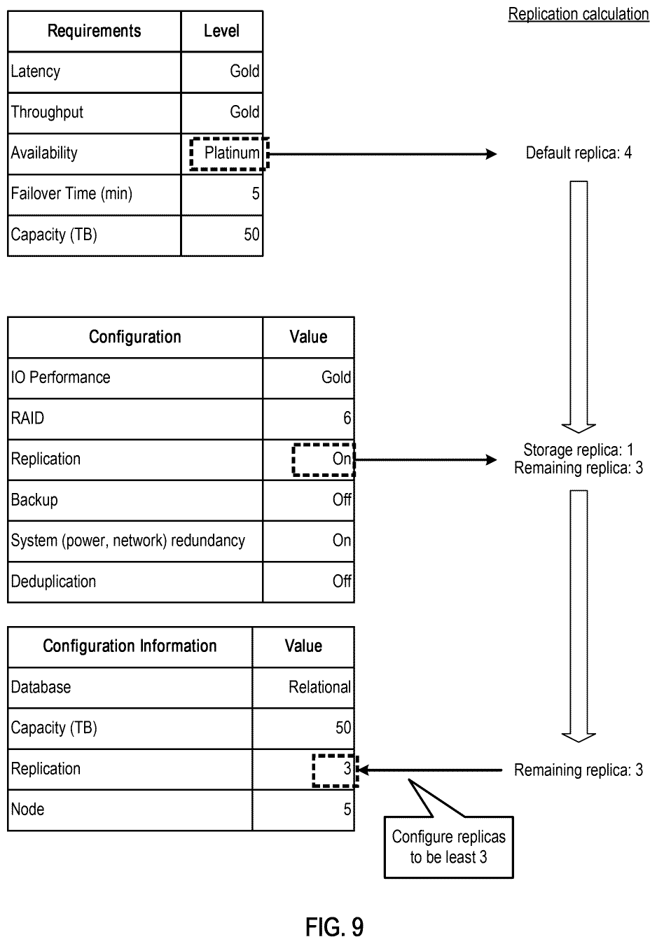

FIG. 9 illustrates another example of configuring the number of replicas in a database system based on availability requirements in steps S100-1 to S100-3, in accordance with an example implementation.

In the example, the system requirements specify that the availability level is set to “Platinum,” which requires a default number of replicas to be 4.

In step S100-2, the Configuration Manager (104) obtains the storage configuration settings and finds that the storage already provides a replication setting with 1 replica.

In step S100-3, the Configuration Manager (104) proposes to configure the database with 3 replicas to meet the total of 4 replicas required for the Platinum availability level while ensuring that the number of replicas is odd.

In step S100-4, the Configuration Manager (104) confirms that the proposed database configuration meets the specified requirements and skips the next step S100-5.

FIG. 10 illustrates an example user interface (UI) (106) for configuring a system based on specific requirements and reviewing the corresponding database configuration, in accordance with an example implementation. The UI can include the following sections and buttons.
System Requirements (1004): Displays the system requirements for latency, throughput, availability, failover time, and capacity. Users or other systems can input or review these requirements.
Submit Button (1001): Allows users to submit the system requirements for processing.
Database Configuration (1005): Displays the proposed configuration of the database system based on the submitted requirements.
Accept Button (1002): Indicates user approval of the proposed database configuration.
Reject Button (1003): Indicates user disapproval of the proposed database configuration.

FIG. 11 illustrates a user interface (UI) (106) for configuring a policy within a system, in accordance with an example implementation.

The UI can involve the following sections and buttons.
Policy (1102): Allows users to define policies for storage functions based on specific system parameters.
Submit Button (1101): Allows users to save and apply the defined policies.

As described herein, there is a system for integrated management of a database system and a storage system, wherein the system is configured to receive system requirements and configuration requests, obtain configuration information of the storage system, and output a database configuration based on the requirements and the configuration information, characterized in that the system optimizes the database configuration according to the system requirements.

As described herein, the system can include the above, wherein the system further determines whether the requirements are adequately met, and proposes the use of certain storage functionalities based on a predefined policy, characterized in that the proposal adjusts the system configuration to meet the requirements more effectively.

As described herein, the system can include the above, wherein, when different types of storage functionalities are present in the storage system, the system prioritizes the proposal of functionalities based on commonality or substitutability of the functionalities, characterized in that the system ensures the optimal use of available storage resources.

As described herein, the system can include the above, wherein the system collects various metrics within the system, and proposes modifications to the database configuration and the use of storage functionalities, characterized in that the system dynamically updates the configuration to maintain performance and efficiency.

As described herein, the system can include the above, wherein the system includes an interface for inputting policies that control the storage functionalities applied when there is an excess or deficiency in meeting the system requirements, characterized in that the interface allows for user-defined adjustments to optimize system performance.

Through the example implementations described herein, an efficient system configuration can be facilitated, as the system automatically generates optimal database configurations based on user requirements and storage system capabilities, reducing manual configuration efforts.

Through the example implementations described herein, there is user decision support, such that the system provides users with proposed configurations and policy-based enhancements, enabling informed decision-making for system optimization.

Through the example implementations described herein, there is resource optimization, such that by considering the duplication and trade-offs of functionalities between the database and storage systems, the example implementations help optimize resource utilization and operational efficiency.

Through the example implementations described herein, there is high availability and reliability, such that the system ensures that the database and storage configurations meet high availability and reliability requirements, enhancing system performance and data integrity.

Through the example implementations described herein, there is cost reduction. By optimizing configurations and resource utilization, the example implementations help reduce operational costs associated with database and storage management.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

1. A method for integrated management of a database system and a storage system, comprising:
receiving a configuration request for deployment of a database comprising system requirements for the database;
obtaining storage configuration information of the storage system to which the database is to be deployed; and
generating a database configuration for the database based on the system requirements and the storage configuration information, the database configuration generated to fulfill the system requirements based on available functionality specified in the storage configuration information,
wherein generating the database configuration comprises integrated management of the database system and the storage system by optimizing resource utilization and reducing operational complexity through enabling or disabling storage functionalities based on commonality or substitutability of the storage functionalities to avoid duplication between database system functionalities and storage system functionalities,
wherein the integrated management comprises automatically configuring the database to use a reduced number of database replicas when the storage system provides replication functionality, thereby avoiding duplication of replication between the database system and the storage system, and
wherein enabling or disabling storage functionalities comprises:
determining that the storage system is configured with RAID 6;
determining that system-level redundancy for power and network is enabled in the storage system;
determining that a number of database replicas in the database configuration exceeds a required number of replicas for meeting an availability requirement in the system requirements; and
based on the determinations, enabling a deduplication functionality of the storage system to reduce redundant data while maintaining the availability requirement.

2. The method according to claim 1, further comprising determining whether the system requirements are fulfilled, and enabling or disabling storage functionalities of the available functionality specified in the storage configuration information based on a predefined policy to adjust the storage configuration information to fulfill the system requirements.

3. The method according to claim 2, further comprising, when different types of the storage functionalities are present in the storage system, enabling or disabling the storage functionalities based on commonality or substitutability of the storage functionalities to optimize available storage resources.

4. The method according to claim 2, further comprising collecting performance metrics, generating modifications to the database configuration and use of the storage functionalities, and dynamically updating the database configuration based on the performance metrics.

5. The method according to claim 2, further comprising facilitating an interface for inputting policies that control the storage functionalities applied when there is an excess or deficiency in meeting the system requirements.

6. A non-transitory computer readable medium, storing instructions for integrated management of a database system and a storage system, the instructions comprising:
receiving a configuration request for deployment of a database comprising system requirements for the database;
obtaining storage configuration information of the storage system to which the database is to be deployed; and
generating a database configuration for the database based on the system requirements and the storage configuration information, the database configuration generated to fulfill the system requirements based on available functionality specified in the storage configuration information,
wherein generating the database configuration comprises integrated management of the database system and the storage system by optimizing resource utilization and reducing operational complexity through enabling or disabling storage functionalities based on commonality or substitutability of the storage functionalities to avoid duplication between database system functionalities and storage system functionalities,
wherein the integrated management comprises automatically configuring the database to use a reduced number of database replicas when the storage system provides replication functionality, thereby avoiding duplication of replication between the database system and the storage system, and
wherein enabling or disabling storage functionalities comprises:
determining that the storage system is configured with RAID 6;
determining that system-level redundancy for power and network is enabled in the storage system;
determining that a number of database replicas in the database configuration exceeds a required number of replicas for meeting an availability requirement in the system requirements; and
based on the determinations, enabling a deduplication functionality of the storage system to reduce redundant data while maintaining the availability requirement.

7. The non-transitory computer readable medium of claim 6, the instructions further comprising determining whether the system requirements are fulfilled, and enabling or disabling storage functionalities of the available functionality specified in the storage configuration information based on a predefined policy to adjust the storage configuration information to fulfill the system requirements.

8. The non-transitory computer readable medium of claim 7, the instructions further comprising, when different types of the storage functionalities are present in the storage system, enabling or disabling the storage functionalities based on commonality or substitutability of the storage functionalities to optimize available storage resources.

9. The non-transitory computer readable medium of claim 7, the instructions further comprising collecting performance metrics, generating modifications to the database configuration and use of the storage functionalities, and dynamically updating the database configuration based on the performance metrics.

10. The non-transitory computer readable medium of claim 7, the instructions further comprising facilitating an interface for inputting policies that control the storage functionalities applied when there is an excess or deficiency in meeting the system requirements.

11. A configuration management system for integrated management of a database system and a storage system, wherein the system comprises:
a processor, configured to:
receive a configuration request for deployment of a database comprising system requirements for the database;
obtain storage configuration information of the storage system to which the database is to be deployed; and
generate a database configuration for the database based on the system requirements and the storage configuration information, the database configuration generated to fulfill the system requirements based on available functionality specified in the storage configuration information,
wherein generating the database configuration comprises integrated management of the database system and the storage system by optimizing resource utilization and reducing operational complexity through enabling or disabling storage functionalities based on commonality or substitutability of the storage functionalities to avoid duplication between database system functionalities and storage system functionalities,
wherein the integrated management comprises automatically configuring the database to use a reduced number of database replicas when the storage system provides replication functionality, thereby avoiding duplication of replication between the database system and the storage system, and
wherein enabling or disabling storage functionalities comprises:
determining that the storage system is configured with RAID 6;
determining that system-level redundancy for power and network is enabled in the storage system;
determining that a number of database replicas in the database configuration exceeds a required number of replicas for meeting an availability requirement in the system requirements; and
based on the determinations, enabling a deduplication functionality of the storage system to reduce redundant data while maintaining the availability requirement.

12. The system according to claim 11, wherein the processor is configured to determine whether the system requirements are fulfilled, and enable or disable storage functionalities of the available functionality specified in the storage configuration information based on a predefined policy to adjust the storage configuration information to fulfill the system requirements.

13. The system according to claim 12, wherein, when different types of the storage functionalities are present in the storage system, the processor is configured to enable or disable the storage functionalities based on commonality or substitutability of the storage functionalities to optimize available storage resources.

14. The system according to claim 12, wherein the processor is configured to collect performance metrics within the system, generate modifications to the database configuration and use of the storage functionalities, and dynamically update the database configuration based on the performance metrics.

15. The system according to claim 12, wherein the processor is configured to provide an interface for inputting policies that control the storage functionalities applied when there is an excess or deficiency in meeting the system requirements.

16. The method according to claim 1,
wherein the deduplication functionality is enabled based on a predefined policy that recognizes the RAID 6 configuration and the system-level redundancy as providing fault tolerance sufficient to allow optimization of storage efficiency through deduplication.

17. The method according to claim 1, wherein generating the database configuration comprises:
determining a required number of database replicas based on an availability level specified in the system requirements; and
obtaining a number of storage replicas provided by the storage system from the storage configuration information; and
calculating a number of database replicas for the database configuration by adjusting the required number of database replicas based on the number of storage replicas to achieve a total replica count that meets the availability level while satisfying database-specific technical constraints.

18. The method according to claim 1, further comprising:
collecting performance metrics from the database system and the storage system during operation, the performance metrics including at least one of reliability metrics or key performance indicators defined in a service level agreement; and
determining that performance has decreased based on the collected performance metrics; and in response to determining that performance has decreased, automatically generating and applying modifications to at least one of the database configuration or enabled storage functionalities to restore performance.

19. The method according to claim 1, wherein the system requirements specify an availability level selected from a plurality of hierarchical service levels, and wherein generating the database configuration comprises determining a default number of database replicas based on the specified availability level, and adjusting the default number based on the storage configuration information and database-specific technical constraints.

20. The method according to claim 1, further comprising:
evaluating the database configuration to determine whether the system requirements are exceeded or not satisfied; and when the system requirements are exceeded or not satisfied, proposing use of at least one storage functionality based on a predefined policy to adjust resource allocation and eliminate redundancy between the database system and the storage system; and
providing a user interface comprising a policy configuration section that allows a user to define policies for enabling or disabling storage functionalities based on system parameters including at least one of RAID configuration, system redundancy status, or replica count; and
a submit button for saving and applying the defined policies to control the integrated management of the database system and the storage system.
